(19) United States
(12) Patent Application Publication
(10) Pub. No.: US 2007/0131727 A1
(43) Pub. Date: Jun. 14, 2007

(54) Gaming device harness

(76) Inventor: Michael C. Martuccio, Girard, OH (US)

Correspondence Address: BROUSE MCDOWELL LPA, 388 SOUTH MAIN STREET, SUITE 500, AKRON, OH, 44311, US

(21) Appl. No.: 11/300,029

(22) Filed: Dec. 14, 2005

(51) Int. Cl. A63F 13/02; A45F 3/14; A45F 3/12

(52) U.S. Cl. 224/257; 224/264; 224/258; 273/148 B

(57) ABSTRACT

A device, including a neck strap suitable for transferring substantially all the weight of the device to the associated user's neck during a prolonged period of substantially uninterrupted use. The neck strap may be adjustable and include a pad to be placed on the user's neck. In another embodiment, a carriage adapted to securely receive a hand held device and a neck strap is taught. The carriage may be suitable for use with an unadapted device such as a video game remote controller, a hand held video game unit, or a communications device having an integrated keyboard.

### I. BACKGROUND OF THE INVENTION

A. Field of Invention

This invention pertains to the art of methods and apparatuses associated with video game controllers, hand held video games, and other hand held devices that may be used for extended periods of substantially uninterrupted time.

B. Description of the Related Art

The use of remote control devices, including video game remote controls and hand held gaming units, for long, substantially uninterrupted periods of time can result in considerable debilitating fatigue in the hands, wrists, arms, shoulders, and back of the associated user. Use of these devices may cause the muscles in the user's back, shoulders, and arms to tense up both in response to having to hold the device in a useable position and having to manipulate a variety of relatively small buttons quickly. After a period of time, that tension can cause muscle fatigue. While each individual can be expected to experience some fatigue, it is understood that the amount of time until fatigue sets in will vary by individual.

Fatigue, in the short term, can undermine the enjoyment of using the device and result in pain throughout the affected areas. In the long term, repeated fatigue caused by use of the device may lead to chronic pain, resulting in conditions such as tendonitis and carpel tunnel syndrome. Despite warnings, provided with many hand-held devices, including video game systems, that players should take periodic rests while playing and should stop playing in the event of fatigue or pain in the arms, wrists, hands, back, shoulders, these warnings may not be read or may be ignored in the context of play, particularly amongst children engrossed in play. Warnings that were once reserved for video game devices are now being extended to hand-held communications devices, particularly those having small, integrated keyboards that can be used to type out documents, e-mails, or other text.

One factor that may increase the speed with which fatigue and pain sets in is the manner in which the user is holding the device. Rarely will a user place the device to rest on a surface that is suitable to support the weight of the unit. More commonly, the user, while standing or sitting, holds the device firmly in one or both hands, away from the body, thereby bearing the weight of the unit while simultaneously trying to manipulate buttons, levers, and knobs on the device. Though video game remote controls, for example, are not extremely heavy, holding these units in this manner for extended periods of time can add to the fatigue and pain associated with game play.

It would be beneficial if the weight of the device could be shifted from the forearms and hands of the user during use of the device, such as by means of a strap that could be operatively affixed to the device and placed around the user's neck. In this way, the weight of the device may be shifted to the user's neck during play, thereby relieving stress in the user's hands, wrists, arms and shoulders.

It would also be beneficial if the harness could be adaptable to retrofit existing hand held devices, without interfering with game play. Further, it would be beneficial if the harness could be adjusted for use with individuals of differing heights and styles of play.

The present invention teaches a strap suitable for use with a hand-held device; namely a hand held video game or video game remote or communications device, having buttons, keys, triggers, joysticks or the like that are manipulated by the associated user's hands for significant periods of substantially uninterrupted time leading to fatigue. The strap, whether integrated with the device or adapted to be secured to a device, is believed to be a first in the industry, being adapted to transfer the weight of the device, and as appropriate, the weight of the associated user's hands and forearms, to the user's neck. While it is known to put cords on devices so as to prevent loss, these cords are generally not long enough to place the device in a comfortably useable position, are not comfortable around the user's neck, and adversely inhibit use of the device by interfering with the device's buttons. The present invention addresses these problems, with a comfortable, adjustable, weight bearing strap that does not interfere with use of the device.

### II. SUMMARY OF THE INVENTION

According to one aspect of the present invention, a new and improved hand-held device is provided which includes a neck strap suitable for transferring substantially all of the weight of the device to the user's neck during an extended period of substantially uninterrupted use, in order to limit fatigue associated with use of the device.

According to another aspect of the invention, the device may be a hand-held video game, a video game remote control, or a hand-held communications device having an integrated keyboard.

According to another aspect of the present invention, the length of the neck strap may be adjustable.

According to another aspect of the invention, the neck strap may be operatively affixed directly to the device.

According to another aspect of the invention, the neck strap may be operatively affixed to the device by means of a clip.

According to another aspect of the invention, the neck strap may be operatively affixed to the device by means of hook and loop fabric.

According to another aspect of the invention, the neck strap may be operatively affixed to the device adhesively.

According to another aspect of the invention, the neck strap may be operatively affixed to the device by means of mechanical fasteners.

According to another aspect of the invention, the neck strap may be removably operatively affixed to the device.

According to another aspect of the invention, the neck strap may include a pad.

According to another aspect of the invention, the pad may be integral with the neck strap.

According to another aspect of the invention, the pad may be slidably received onto the neck strap.

According to another aspect of the invention, a carriage adapted for securely receiving a handheld gaming device is provided which is further adapted to receive a neck strap suitable for transferring substantially all the weight of the device to the user's neck during game play.

According to another aspect of the invention, the carriage may be constructed of flexible manmade or natural materials.

According to another aspect of the invention, the carriage does not interfere with access to the hard buttons of the device.

According to another aspect of the invention, the carriage may be elastic.

According to another aspect of the invention, the carriage may be comprised of a framework of fabric straps.

According to another aspect of the invention, the neck strap may be operatively attached to the carriage by means of clips.

According to another aspect of the invention, the neck strap may be attached to the carriage by means of hook and loop fabric.

According to another aspect of the invention, the neck strap may be attached to the carriage by means of snaps.

According to another aspect of the invention, the neck strap may be attached by means of sewing or mechanical fasteners.

According to another aspect of the invention, the neck strap may be integral with the carriage.

According to another aspect of the invention, the neck strap may include a pad.

According to another aspect of the invention, the pad may be a deformable material.

According to another aspect of the invention, the pad may be slidably received onto the neck strap.

According to another aspect of the invention, the neck strap may be adjustable.

According to one aspect of the present invention, the handheld gaming device may be a video game remote control.

According to another aspect of the present invention, the handheld gaming device may be a handheld video game unit.

According to another aspect of the invention, a method of using a hand-held device, which may be a video game remote control, a video game unit, or a communications device having an integrated keyboard, is taught, which may include providing a strap for transferring substantially all of the weight of the device to the user's neck during use of the device, the strap adapted to reduce fatigue in the associated user's arms.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is a plan view of a handheld gaming device adapted to receive a neck strap 10 according to one aspect of the present invention.

FIG. 2 is a plan view of the device depicted in FIG. 1 showing an alternate attachment point of the neck strap on the near edge of the device.

FIG. 3 is a plan view of an alternate embodiment of the present invention showing a handheld gaming device adapted to receive a neck strap according to the present invention.

FIG. 4 is a view showing the neck strap as it may be used in conjunction with a handheld communications device.

FIG. 5 is plan view of a handheld gaming device showing a carriage adapted to receive a handheld gaming device with an associated neck strap adapted to be received onto the carriage.

FIG. 6 is an alternate view depicting an alternate view of the carriage according to the present invention.

### IV. DESCRIPTION OF THE PREFERRED EMBODIMENT

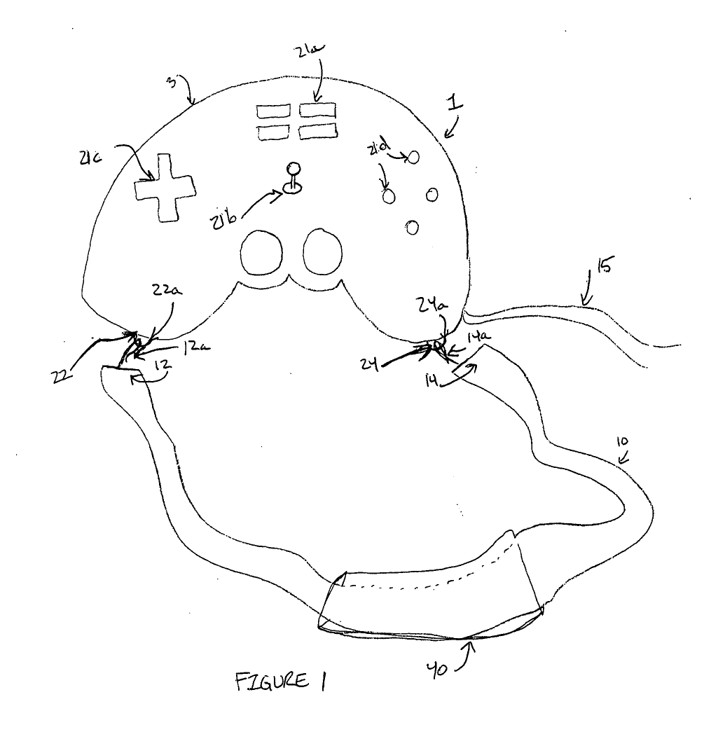

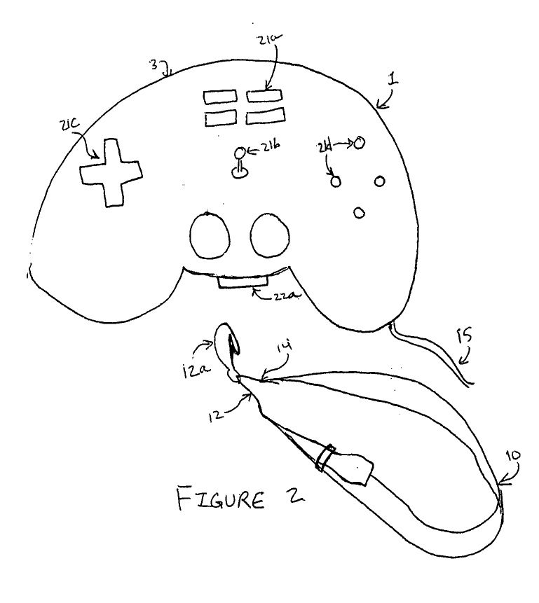

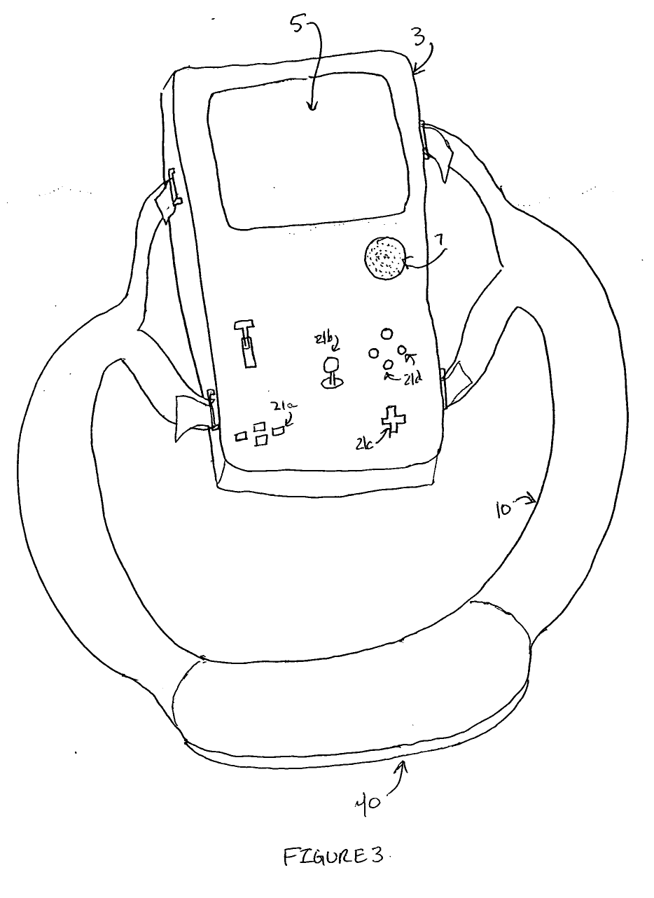

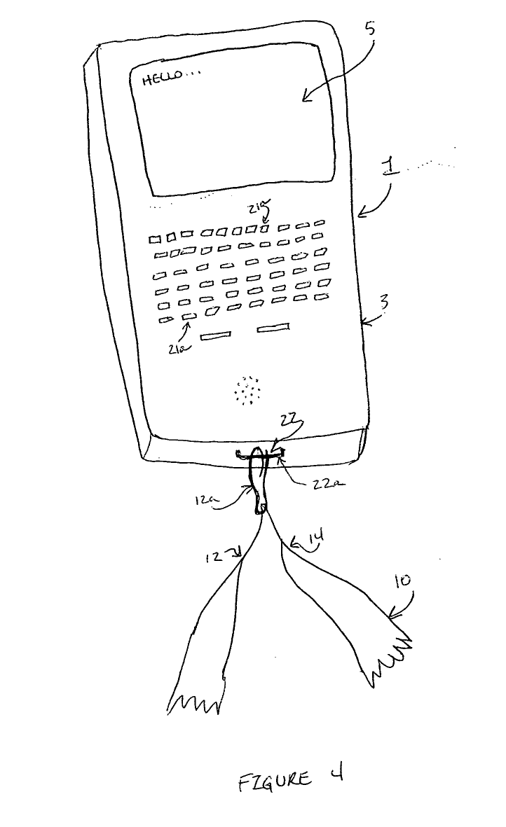

Referring now to the drawings wherein the showings are for purposes of illustrating a preferred embodiment of the invention only and not for purposes of limiting the same, FIGS. 1-4 show variations of a device 1 adapted to be operatively attached to a neck strap 10. The device 1 may be adapted to be held with both hands of an associated user. Further, the device 1 may be adapted with a plurality of hard buttons that are intended to be manipulated, while the device is being held, by the fingers on one or both of the associated user's hands for an extended period of substantially uninterrupted time, which would be likely to lead to fatigue in the user's hands and forearms. Such devices 1 according to the present invention include devices that are commonly used for purposes of controlling video game play or for drafting based documents. Exemplary of such devices according to the present invention, in one embodiment, shown in FIGS. 1 and 2, the device 1 may be a video game remote control, such as would be used in conjunction with external video gaming software or hardware to control a game output, which may be a visual output on a computer or television screen 5. The video game remote control, depicted generally in FIGS. 1 and 2, may be wireless or include a wire 15 for transmitting the signals from the hard buttons 21a, 21b, 21c, 21d to the game control system (discussed below). In another embodiment, the device 1 may be a self-contained video game unit, such as is depicted in FIG. 3. By “self contained” it is meant that the game output emits directly from the device 1. In still another embodiment, the device 1 may be a handheld communications tool that may be used by the associated user to type text. Such devices may include an integrated keyboard as shown in FIG. 4.

With reference to FIGS. 1-3, the device 1 may be a gaming device. The gaming device 1 may include a housing 3. The housing 3 may be constructed from a single preform panel or a plurality of pre-formed panels fixed together, such as with mechanical fasteners, welding, adhesives or any other suitable means known in the art. The housing 3 may be adapted to be held in both hands of the associated user, while allowing the associated user to manipulate the hard buttons (discussed below) 21a, 21b, 21c, 21d at the same time. The shape of the housing 3 may vary depending on the nature of the video game being played and the location of the hard buttons 21a, 21b, 21c, 21d. The housing 3 may be ergonomically shaped to fit the associated user's hands. The housing 3 may be constructed of one or more materials, including plastic or metal.

With continued reference to FIGS. 1-3, the housing 3 may be a substantially hollow body that defines a cavity. The housing 3 may have an inner surface and an outer surface. The interior of the housing 3 may house electronic circuitry (not shown) adapted to transmit one or more signals operatively produced from one or more hard buttons 21a, 21b, 21c, 21d extending from the outer surface of the housing 3, to a game control system (not shown). The term “hard buttons” refers to all of the mechanical control buttons on the device 1, including, for example the buttons, triggers, joysticks, and keyboard keys. The term “game control system” is broadly defined to include the hardware and software that is necessary to receive the signal produced by manipulation of the hard buttons and effectuate a responsive change in the game output.

The housing 3, such as in a self-contained video game unit, may include a screen 5 suitable for visually displaying the game output. Alternatively or additionally, the device 1 may include a speaker 7 for audio emission of the game output.

Referring now to FIGS. 1 and 3, there is a neck strap 10 operatively attached to the housing 3 of the device 1. The neck strap 10 may take one of many forms, but generally includes a length of flexible material having first and second ends 12, 14. In one embodiment, the first and second ends 12, 14 of the neck strap 10 may be operatively attached to the exterior surface of the housing 3 at distinct points. The points of attachment 22, 24 of the first and second ends 12, 14 of the neck strap 10 are preferably selected so that the neck strap 10 does not impede the normal use of the gaming device 1. As shown in FIGS. 1 and 3, the points of attachment 22, 24 may be positioned along the right or left edges of the device 1. As shown in FIG. 2, the points of attachment, 22, may be located on the near edge of the device 1. It will be understood that other points of attachment may be selected with sound engineering judgment. Additionally, the points of attachment 22, 24 of the first and second ends 12, 14 of the neck strap 10 may be selected so that the gaming device 1 remains in a substantially upright position when the user releases the device 1. By “substantially upright position”, it is meant that the neck strap 10 supports the device 1, such that when the device 1 is not being held by the user, it remains substantially in the same position, rotationally and vertically, as when the device 1 is being held by the user. In this way, the user can let go of the device 1 momentarily and return to it quickly.

The first and second ends 12, 14 of the neck strap 10 may be operatively attached to the housing 3 by means of mechanical fasteners or adhesives. The first and second ends 12, 14 of the neck strap 10 may be removably, operatively attached to the housing 3 so that the neck strap 10 can be removed from the device 1. In this embodiment, the first and second ends 12, 14 of the neck strap 10 may include fastening clips 12a, 14a adapted to removably clip into retaining rings 22a, 24a mounted to the exterior surface of the housing 3. The retaining rings 22a, 24a may be integrally formed into the exterior surface of the housing 3 or they may be fixedly attached to the exterior surface of the housing 3 such as with adhesives or welding or mechanical fasteners. Alternatively, a hook and loop strip may be used to removably operatively attach the first and second ends 12, 14 of the neck strap 10 to the housing 3. The loop portion may be fixed to the surface of the housing 3 and the loop portion may be fixed to the first and seconds ends 12, 14 of the neck strap 10.

It will be noted that the neck strap 10 may be operatively attached to the housing 3 at two points. However, as shown in FIG. 3 the neck strap 10 may easily be operatively attached to the housing 3 at less than or more than two points. For example, the first and second ends 12, 14 of the neck strap 10 may be joined together to form a single terminal neck strap 10 end that may be attached to the housing 3 at a single point of contact (as shown in FIG. 2). Alternatively, the first and second ends 12, 14 of the neck strap 10 may be bifurcated into more than one arm (as shown in FIG. 3), each arm terminating in an attachment point on the housing 3.

The neck strap 10 may be constructed of any suitable, flexible material. The material may be natural or synthetic. In one embodiment, the material may be leather. In another embodiment, the material may be nylon. The neck strap 10 is adapted to transfer substantially all the weight of the held device 1 to the user's neck, thereby, it is believed, reducing the hand, arm, and shoulder strain associated with prolonged, essentially uninterrupted use of the device 1. The length of the neck strap 10 should be selected to allow the attached device 1 to hang before the associated user at an appropriate vertical operating level. The length of the neck strap 10 may be fixed. Alternatively, the length of the neck strap 10 may be adjustable according to methods well known in the art. By having an adjustable strap, the device 1 may be used by persons of differing height as well as the same person going from a standing to a sitting position.

The neck strap 10 may include a pad 40 along its length. The pad 40 may be integral with the neck strap 10 as shown in FIG. 2. Alternatively, the pad 40 may be separate from, but operatively received by the neck strap 10 as shown in FIG. 1. The pad 40 may serve to prevent chafing on the neck of the associated user. In the respect, the pad 40 may be constructed of a relatively soft material, such as cotton. Additionally, or alternatively, the pad 40 may be constructed of a deformable foam material. The pad 40 may be constructed from any other suitable material. The pad 40 may be slidably received by the neck strap. In this way, the pad 40 may be positioned along the neck strap 10 so as to align with the user's neck.

To use this embodiment of the invention, it is contemplated that the associated user would place the neck strap 10 of the device about his neck, taking care to align the pad 40, if available, on his neck. The length of the neck strap 10 could be adjusted to place the device 1 at the optimum location vertically so that, when the device 1 is in use, the weight of the device 1 is substantially borne by the neck strap 10 and the user's neck. In this way, the user can relax his arms and shoulders, which are no longer needed to hold up the device 1. When released, the device 1 may remain substantially in a useable position and accessible to the user. It is contemplated that the user would use the device 1 for a prolonged period of substantially uninterrupted use.

It is noted that the length of time of substantially uninterrupted use of a device according to the present invention, which will lead to fatigue, will vary by user. It is recommended, however, that video game users take a 10 to 15 minute break for each hour of play to prevent repetitive strain disorders. For purposes of this invention, the term “prolonged period” shall refer to at least 50 minutes. For purposes of this invention, the term “substantially uninterrupted” shall mean the user holds the device for at least 50 minutes in a one hour period.

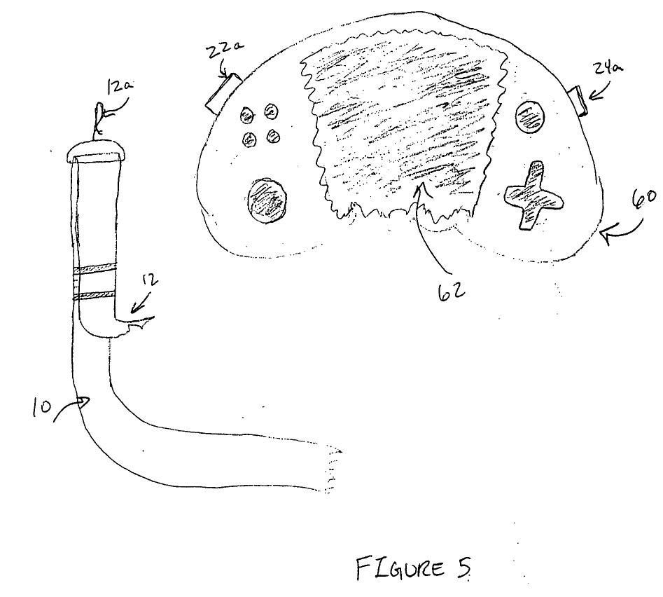

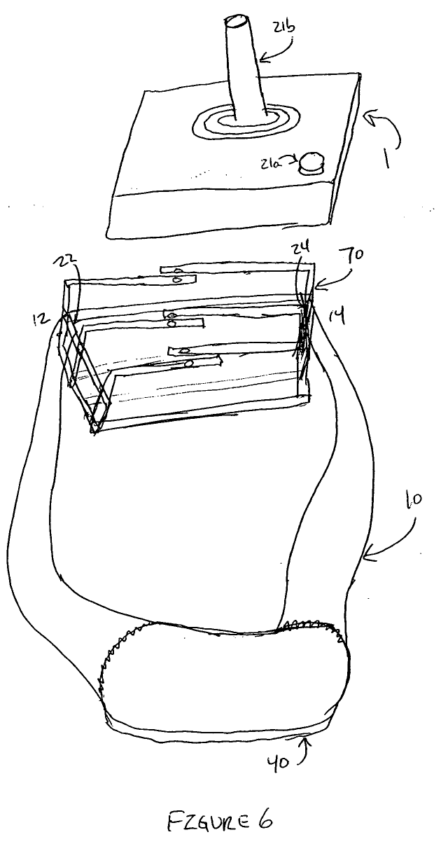

A second embodiment of the invention is shown in FIG. 5. This embodiment is particularly directed to providing the benefits of a neck strap 10 to a device 1 having a housing 3 not already adapted for receiving a neck strap 10. In this embodiment, there may be a carriage 60 adapted to securely, removable retain the device 1 while allowing the associated user access to the hard buttons 21a, 21b, 21c, 21d. The carriage 60 may be a fabric “glove” having a mouth 62 into which the device 1 may be placed and openings 65, 67 corresponding to the various hard buttons 21a, 21b, 21c, 21d. Alternatively, as shown in FIG. 6, the carriage 60 may be a flexible framework of retaining straps 70 adapted to surround the device 1 and securely retain it in place. The retaining straps 70 may be constructed of any suitable, flexible material. The retaining straps 70 may be elastic. The retaining straps 70 may incorporate a hook and loop strip to tightly secure the straps about the device 1. It should be understood that there are many ways to secure the device 1 in a flexible carriage 60.

As shown in FIGS. 5 and 6, there may be a neck strap 10 as previously described above, operatively connected to the carriage 60. The neck strap 10 may take one of many forms, generally being a length of flexible material having first and second ends 12, 14. In one embodiment, the first and second ends 12, 14 of the neck strap 10 may be operatively attached to the carriage 60 at distinct points. The points of attachment 22, 24 of the first and second ends 12, 14 of the neck strap 10 may be selected so that the neck strap 10 does not impede the normal use of the gaming device 1. Additionally, the points of attachment 22, 24 of the first and second ends 12, 14 of the neck strap 10 may be selected so that the gaming device 1 remains in a substantially upright position when the user lets go of the device 1.

The first and second ends 12, 14 of the neck strap 10 may be operatively attached to the carriage 60 by means of mechanical fasteners or adhesives. The first and second ends 12, 14 of the neck strap 10 may be removably, operatively attached to the carriage 60 so that the neck strap 10 can be removed from the carriage 60. In this embodiment, the first and second ends 12, 14 of the neck strap 10 may include fastening clips 12a, 14a adapted to removably clip into retaining rings 22a, 24a mounted to the carriage 60. The retaining rings 22a, 24a may be integrally formed into carriage 60 or they may be fixedly attached or integral to the carriage 60. Alternatively, a hook and loop strip may be used to removably operatively attach the first and second ends 12, 14 of the neck strap 10 to the carriage 60. In still another embodiment, the neck strap 10 may be integrally formed with the carriage 60.

It will be noted that the neck strap 10 may be operatively attached to the carriage 60 at two points. However, the neck strap 10 may easily be operatively attached to the carriage 60 at less than or more than two points as previously described with respect to FIG. 3.

The neck strap 10 may be constructed of any suitable, flexible material. The material may be natural or synthetic. In one embodiment, the material may be leather. In another embodiment, the material may be nylon. The length of the neck strap 10 should be selected to allow the attached device 1 to hang before the associated user at an appropriate vertical operating level. The length of the neck strap 10 may be fixed. Alternatively, the length of the neck strap 10 may be adjustable according to methods well known in the art. By having an adjustable neck strap 10, the device 1 may be used by persons of differing height as well as the same person going from a standing to a sitting position.

The neck strap 10 may include a pad 40 along its length. The pad 40 may be integral with the neck strap 10. Alternatively, the pad 40 may be separate from, but operatively received by the neck strap 10. The pad 40 may serve to prevent chafing on the neck of the associated user. The pad 40 may be constructed of materials as previously described. The pad 40 may be slidably received by the neck strap 10. In this way, the pad 40 may be positioned along the neck strap 10 so as to align with the user's neck.

To use this embodiment of the invention, it is contemplated that the associated user would secure the gaming device 1 in the carriage 60, place the neck strap 10 about his neck, taking care to align the pad 40, if available, on his neck. The length of the neck strap 10 could be adjusted to place the device 1 at the optimum location vertically so that, when the device 1 is in use, the weight of the device 1 is substantially borne by the neck strap 10 and the user's neck. In this way, the user can relax his arms and shoulders, which are no longer needed to hold up the device 1. When released, the device 1 may remain substantially in position and accessible to the user. It is contemplated that the user would use the device 1 for a prolonged period of substantially uninterrupted use.

Having generally described the device 1 as a gaming device 1, and preferably a video game remote control or a self-contained video game unit, it is noted that the invention is applicable to any hand-held device 1, the use of which involves significant manipulation of hard buttons 21a, 21b, 21c, 21d, while the unit is being held, for a significant period of uninterrupted time.

The preferred embodiments have been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

Having thus described the invention, it is now claimed:

I/we claim:

1. A device comprising;
a housing, adapted to be held by both of an associated user's hands, the housing having an inner surface and an outer surface;
electronic circuitry set substantially within the housing, for transmitting at least first and second signals;
at least a first and second hard buttons extending from the outer surface of the housing, the at least a first hard button adapted to be manipulated by an associated user's right hand, the at least a first hard button operatively communicated with the electronic circuitry for creating the at least a first signal, and the at least a second hard button adapted to be manipulated by the associated user's left hand, the at least a second hard button operatively communicated with the electronic circuitry for creating the at least a second signal;
a neck strap operatively attached to the housing, the neck strap suitable for transferring substantially all of the weight of the device to the associated user's neck when the associated user is manipulating one of the at least a first or second hard buttons.

2. The device of claim 1, wherein the neck strap is removably operatively attached to the housing 3.

3. The device of claim 2 wherein the wherein the neck strap has a length and the length is adjustable.

4. The device of claim 2, further comprising:
a deformable pad received onto the neck strap.

5. The device of claim 4, wherein the deformable pad is slidably received onto the neck strap.

6. The device of claim 1, further comprising:
a display screen received by the housing,
a game control system adapted to receive the at least first and second signals.

7. A harness for a hand held video game device, the harness comprising:
a flexible carriage adapted to securely receive a hand held video game device, the hand held video game device sized to be held with two hands;
a neck strap operatively attached to the carriage, the neck strap suitable for transferring substantially all of the weight of the hand held video game device to the associated user's neck when the associated user is using the hand held video game device.

8. The harness of claim 7, wherein the hand held video game device is a video game remote control.

9. The harness of claim 7, wherein the hand held video game device is a hand held video game.

10. The harness of claim 7, wherein the hand held video game device is a wireless hand held video game device.

11. The device of claim 7, wherein the neck strap is removably operatively attached to the carriage.

12. The device of claim 11, wherein the wherein the neck strap has a length and the length is adjustable.

13. The device of claim 12, wherein the neck strap includes a deformable pad.

14. The device of claim 13, wherein the deformable pad is slidably received onto the neck strap.

15. A method of using a hand-held device, the method comprising the steps of:
providing a device, the device comprising:
a housing, adapted to be held by both of an associated user's hands, the housing having an inner surface and an outer surface;
at least a first and second hard buttons extending from the outer surface of the housing, the at least first and second hard buttons being adapted to be manipulated while the device is being held, the at least a first hard button adapted to be manipulated by an associated user's first hand and the at least a second hard button adapted to be manipulated by the associated user's second hand;
providing a neck strap operatively attached to the housing, the neck strap suitable for transferring substantially all of the weight of the device to the associated user's neck when the associated user is holding the device in both hands;
placing the neck strap around the associated user's neck;
holding the device in both hands; and
manipulating one of the at least a first or second hard buttons, substantially uninterrupted, for a prolonged period of time.
